(19) United States
(12) Patent Application Publication
(10) Pub. No.: US 2013/0283959 A1
(43) Pub. Date: Oct. 31, 2013

(54) AIRCRAFT BRAKE HANDLE ASSEMBLY

(71) Applicants: Hiroki Oyama, Summerfield, NC (US); Katsutoshi Tada, Tokyo (JP); Charles T. O'Connell, Summerfield, NC (US)

(72) Inventors: Hiroki Oyama, Summerfield, NC (US); Katsutoshi Tada, Tokyo (JP); Charles T. O'Connell, Summerfield, NC (US)

(73) Assignee: HONDA PATENTS & TECHNOLOGIES NORTH AMERICA, LLC, Torrance, CA (US)

(21) Appl. No.: 13/879,660

(22) PCT Filed: Oct. 14, 2011
(86) PCT No.: PCT/US11/56484

§ 371 Date: Jul. 1, 2013

Related U.S. Application Data
(60) Provisional application No. 61/394,249, filed on Oct. 18, 2010.

(51) Int. Cl. G05G 5/00; G05G 1/04

(52) U.S. Cl. CPC G05G 5/005; G05G 1/04
USPC 74/490.14

(57) ABSTRACT

A brake handle assembly for an aircraft emergency/parking brake includes a handle movable between a non-actuated position wherein the brake is disengaged and a full actuated position wherein, during movement therebetween, the brake applies a modulated braking force in an emergency brake state. A button actuator is disposed on the handle. Movement of the handle from the intermediate stop position to the full actuated position is obstructed to prevent inadvertent operation of the brake in the parking brake state unless the button actuator is depressed.

This application claims the benefit of U.S. provisional patent application Ser. No. 61/394,249, filed Oct. 18, 2010, which is incorporated by reference in its entirety herein.

### BACKGROUND

The present disclosure generally relates to aircraft braking systems, and more particularly relates to a brake handle assembly for an aircraft emergency/parking brake.

Many types of aircraft, including small business jets, use power braking systems as the primary braking means for the aircraft. To deal with an unexpected failure of the power braking system, a non-powered redundant braking system is typically provided. One such redundant braking system includes a modulating emergency/parking brake valve in combination with an accumulated power device. The brake valve can direct a pressurized fluid (e.g., hydraulic or brake fluid, compressed air, etc.) from the accumulator to apply the aircrafts brakes when the primary braking system fails. In addition to providing emergency braking, the brake valve can also fully engage the brakes for long term parking.

Typically a control lever or other activated mechanism in the cockpit is mechanically connected to the brake valve to control the flow of pressurized fluid in the aircraft's hydraulic system to and from the brake cylinders at the wheels of the aircraft. In particular, an amount of braking pressure applied by the brake valve can correspond to the position of the control lever, which is operated by the pilot. Unfortunately, it can be difficult to precisely control applied brake pressure and supply appropriate aircraft deceleration using the control lever without causing wheel lock. Wheel lock is undesirable in that it can lead to a potential burst tire.

### SUMMARY

According to one aspect, a brake handle assembly for an aircraft emergency/parking brake includes a handle movable between a non-actuated position wherein the brake is disengaged and a full actuated position wherein, during movement therebetween, the brake applies a modulated braking force in an emergency brake state. A button actuator is disposed on the handle. Movement of the handle from the intermediate stop position to the full actuated position is obstructed to prevent inadvertent operation of the brake in the parking brake state unless the button actuator is depressed.

According to another aspect, an aircraft brake handle assembly includes a handle longitudinally movable in a first direction from a non-actuated position to an intermediate stop position for applying a modulated braking force. Movement of the handle in the first direction beyond the intermediate stop position is prevented by an obstructing assembly. A button actuator is disposed on the handle and is operatively connected to the obstructing assembly. Actuation of the button actuator disengages the obstructing assembly to allow movement of the handle in the first direction from the intermediate stop position to a full actuated position for applying a parking brake.

According to still another aspect, a handle assembly for an aircraft braking system includes a handle, a button actuator disposed on the handle, a guide track defining a guide track and a pin received in the guide track. The handle is movable from a non-actuated position to an intermediate stop position for applying a modulated emergency braking force. The handle is further movable from the intermediate stop position to a full actuated position for applying a parking brake. The handle is movable relative to the guide track member and the guide track. The pin is connected to the handle for movement therewith such that the pin moves longitudinally along the guide track as the handle is moved. Cooperation between the pin and the guide track prevents continued longitudinal movement of the pin to prevent corresponding movement of the handle from the intermediate stop position to the full actuated position. The button actuator is configured to laterally move the pin in the guide track when the handle is at the intermediate stop position to allow further longitudinal movement of the pin in the guide track and corresponding movement of the handle from the intermediate stop position to the full actuated position when the button actuator is actuated.

### BRIEF DESCRIPTION OF THE DRAWINGS

FIG. 1 is a partial perspective view of an aircraft emergency/parking brake system showing a brake handle assembly disposed in an aircraft cockpit area and mechanically connected to a forwardly disposed brake valve.

FIG. 2 is a schematic system diagram illustrating the aircraft emergency/parking brake system.

FIG. 3 is a cross-sectional view of the brake handle assembly shown removed from the cockpit area.

FIG. 4 is a cross-sectional view of the brake handle assembly taken along the line 4-4 of FIG. 3.

FIG. 5 is a cross-sectional view taken along the line 5-5 of FIG. 3.

FIG. 6 is an elevational view of a guide track link of the brake handle assembly.

FIG. 7 is an elevational view of a handle link of the brake handle assembly.

FIG. 8 is a button link of the brake handle assembly.

FIG. 9 is a schematic elevational view of the brake handle assembly shown in a non-actuated position.

FIG. 9A is a cross-sectional view of the brake handle assembly of FIG. 9.

FIG. 10 is a schematic elevational view of the brake handle assembly shown in an intermediate stop position before a button actuator is depressed.

FIG. 10A is a cross-sectional view of the brake handle assembly of FIG. 10.

FIG. 11 is a schematic elevational view of the brake handle assembly shown in the intermediate stop position shown with the button actuator depressed.

FIG. 11A is a cross-sectional view of the brake handle assembly of FIG. 11.

FIG. 12 is a schematic elevational view of the brake handle assembly shown in a full actuated position.

FIG. 12A is a cross-sectional view of the brake handle assembly of FIG. 12.

FIG. 13 is a schematic elevational view of the brake handle assembly shown locked in the full actuated position.

FIG. 13A is a cross-sectional view of the brake handle assembly of FIG. 13.

### DETAILED DESCRIPTION

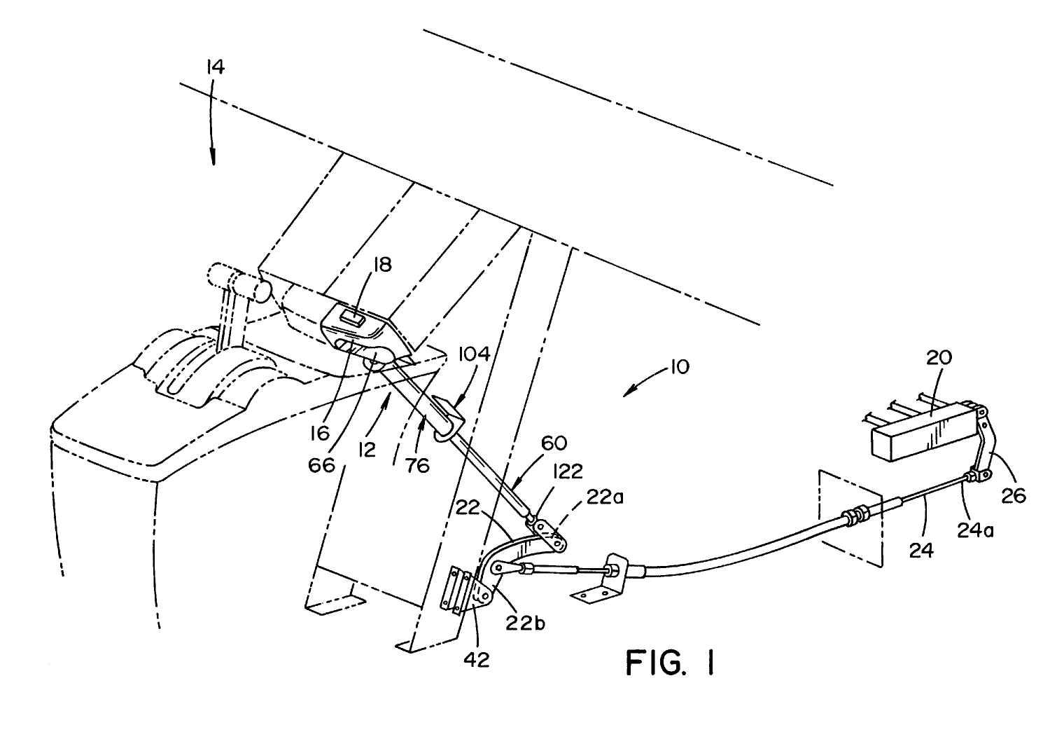

Referring now to the drawings wherein the showings are only for purposes of illustrating one or more exemplary embodiments and not for purposes of limiting same, FIG. 1 illustrates an aircraft emergency/parking brake system 10 having a brake handle assembly 12 disposed in a cockpit area 14 of an aircraft. In the illustrated embodiment, the brake handle assembly 12 includes a handle 16 provided for selectively applying a modulated emergency braking force in an emergency brake state and a locked or fully engaged braking force in a parking brake state. The handle assembly 12 further includes a button actuator 18 disposed on the handle 16 for enabling the handle to be moved so as to change actuation of the modulated braking force in the emergency brake state to the locked/fully engaged braking force in the parking brake state. As will be described in more detail below, the handle 16 of the illustrated embodiment is mechanically connected to an emergency/parking brake valve 20 by a pivotal link 22 and a push-pull cable 24.

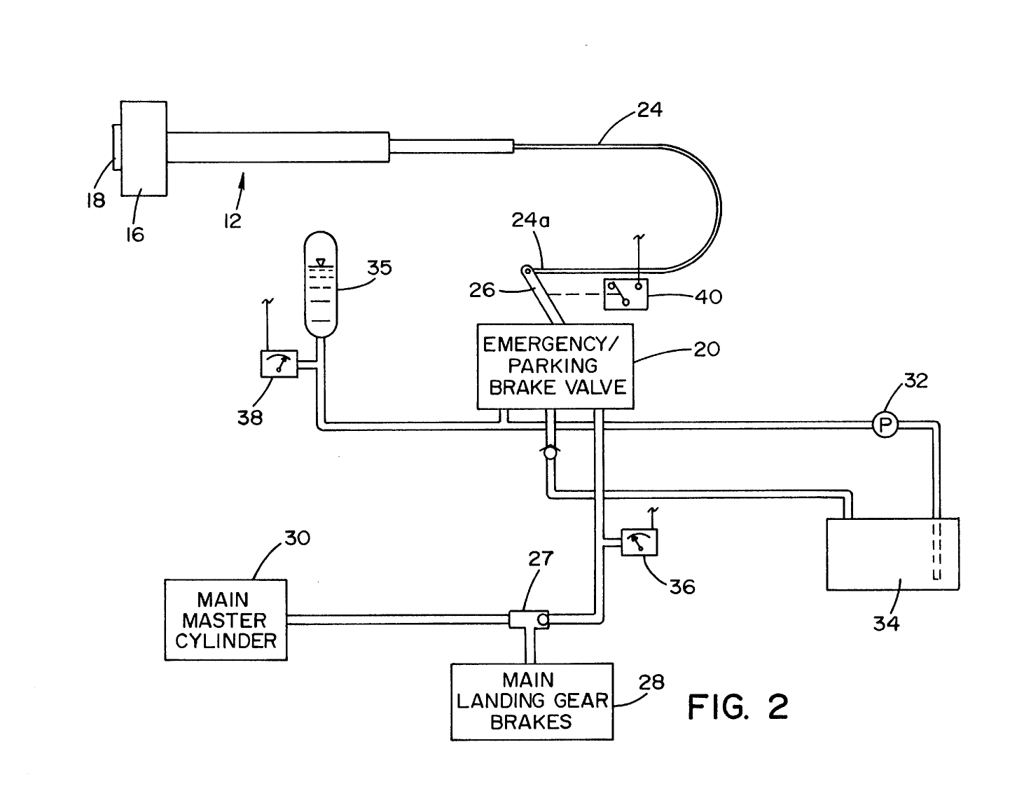

The brake handle assembly 12 has two stages (i.e., the emergency brake state and the parking brake state). In the first stage, the emergency brake state, a modulated braking force can be applied without wheel lock and such modulated braking force can be precisely controlled to prevent tire burst. The second stage, the parking brake state, is a full brake pressure application for parking and/or maximum brake force. With additional reference to FIG. 2, the brake handle 16 is again shown mechanically connected to the brake valve 20 by the cable 24 (the pivotal link 22 is not shown). In particular, one end 24a of the cable 24 connects to a movable lever 26 of the brake valve 20 for operation of the brake valve. The brake valve 20 controls a fluid force (e.g., a hydraulic fluid force) applied to the main landing gear brakes 28. Such braking force to the main landing gear brakes 28 is supplemental to the fluid force applied by the aircraft's primary braking system, which can be controlled by a main master cylinder 30. In particular, a fluid component 27 can route or control pressurized fluid to the brakes 28 (e.g., the component 27 can include a check valve that normally closes fluid communication between the valve 20 and the brakes 28 when the master cylinder 30 is providing fluid pressure, but allows such communication when the master cylinder is providing insufficient fluid pressure).

More particularly, the handle 16 is mechanically connected to the emergency/parking brake valve 20 so that the position of the handle 16 is mechanically communicated to the valve 20. In particular, the handle 16 is mechanically connected to the brake valve 20 by the push/pull cable 24 that transmits pushing and pulling action of the handle 16 to the valve 20, and particularly to the lever 26 of the valve 20. The handle 16 is further mechanically connected to the brake valve 20 by the pivotal link 22. The pivotal link 22 has one end 22a connected to the handle 16 for linear movement therewith and a second end 22b connected to the push/pull cable 24 for linear movement therewith. The pivotal link 22 is pivotally connected to a fixed mounting 42 so that pulling movement of the handle 16 is translated to pulling action of the push/pull cable 24 and pushing action on the handle 16 is translated to pushing action of the push/pull cable 24.

Fluid pressure controlled by the brake valve 20 can be supplied by a pump 32 fluidly connected to a fluid reservoir 34. Fluid pressure to the brake valve 20 can also be supplied by an accumulator 35, which can be relied upon in the condition that the pump 32 fails (e.g., loses power). As is known and understood by those skilled in the art, fluid pressure gauges 36, 38 can be provided, such as first fluid pressure gauge 36 between the brake valve 20 and the main landing gear brakes 28 to measure fluid pressure delivered to the main landing gear brakes 28 and second fluid pressure gauge 38 fluidly disposed between the pump 32 and the accumulator 35 for measuring a fluid pressure from the pump 32 and/or the accumulator 35. An electrical switch 40 can also be provided as shown operatively connected to the brake valve lever 26 for switching between an off position when the brake lever 26 is in a non-actuated position corresponding to a non-actuated position of the brake handle 16 and an on position when the brake lever 26 is in any other position corresponding to the brake handle 16 being in any other position than the non-actuated position. The switch 40 can be used, for example, for illuminating an indicator (not shown) in the cockpit 14 to indicate that emergency and/or parking braking is being applied by the brake valve 20.

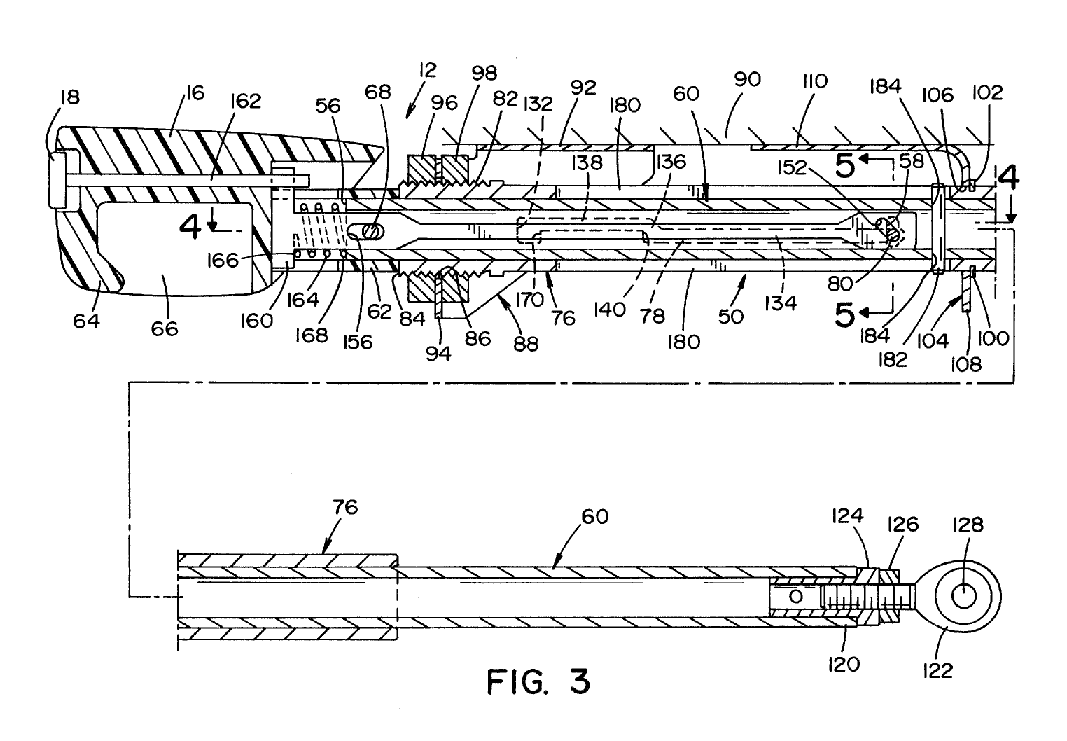

With reference to FIGS. 3-5, the brake handle 16 is shown in the non-actuated position. The handle 16 is longitudinally movable in a first direction (to the left in FIG. 3) from the illustrated non-actuated position to an intermediate stop position for applying a modulated emergency braking force. Movement of the handle 16 in the first direction beyond the intermediate stop position is prevented by an obstructing assembly 50. Accordingly, the handle 16 is freely movable from the non-actuated position to the intermediate stop position wherein during movement there between the brake 28 applies a modulated braking force in the emergency brake state.

The button actuator 18 disposed on the handle 16 is operatively connected to the obstructing assembly 50. Actuation of the button actuator 18, as will be described in more detail below, disengages the obstructing assembly 50 to allow movement of the handle 16 in the first direction from the intermediate stop position to a full actuated position for applying the brake 28 as a parking brake (i.e., full application of the braking force from the brake is applied) in a parking brake state. By this arrangement, the handle 16 is movable between the non-actuated position wherein the brake is disengaged and the full actuated position wherein the brake is fully engaged in the parking brake state, though movement of the handle 16 from the intermediate stop position to the full actuated position is obstructed to prevent inadvertent operation of the brakes 20 in the parking brake state unless the button actuator 18 is depressed (i.e., the button actuator 18 communicating the pilot's intention to activate the parking brake).

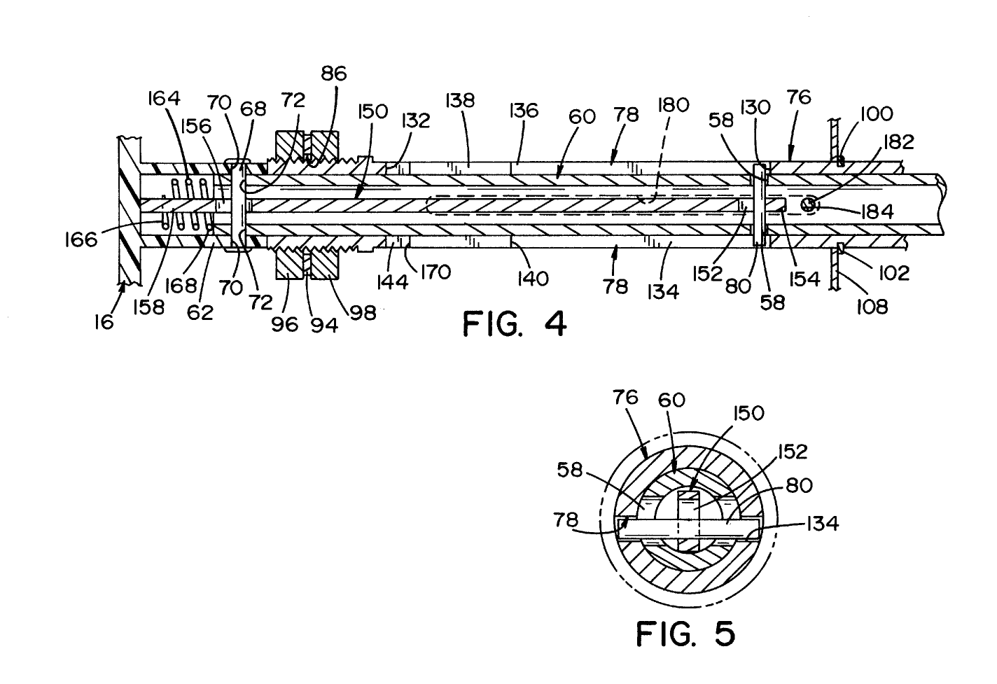

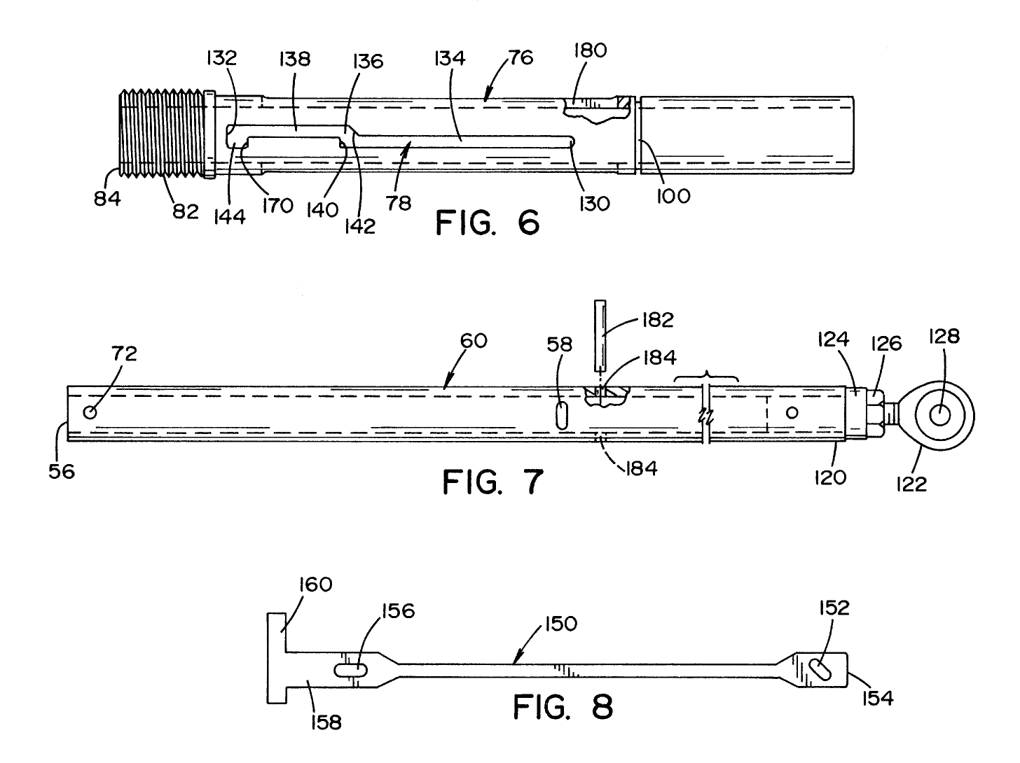

The brake handle assembly 12 includes a handle link 60 (shown in isolation in FIG. 7) connected to the handle 16. The handle link 60 longitudinally moves with the handle 16 as the handle is moved between the non-actuated position and the fully engaged position and to any position between the non-actuated position and the fully engaged position, including the intermediate stop position. In the illustrated embodiment, the handle link 60 is tube-shaped and has a first end 56 received within a tubular portion 62 of the handle 16 and fixedly secured thereto. The handle 16 includes a gripping portion 64 disposed adjacent an underside recess 66 which enables a pilot to easily manipulate the handle 16 for longitudinal movement thereof along with longitudinal movement of the handle link 60. As best shown in FIG. 4, a rivet-type pin 68 can fixedly secure the handle link 60 to the handle 16, and particularly the tubular portion 62 of the handle 16. Accordingly, the pin 68 can be received through apertures 70 defined in the tubular portion 62 and through apertures 72 (one shown in FIG. 7), which are in registry with the apertures 70. A distal end 120 of the handle link 60 can be secured to the pivotal link 22 via an attaching member 122. As shown, the attaching member 122 is secured to the distal end 120 by mounting members 124, 126 and includes an aperture 128 for connecting the attaching member 122 to the pivotal link 22 via a suitable fastener (not shown).

The brake handle assembly 12 further includes a guide track link 76 (shown in isolation in FIG. 6) having a guide track 78 defined therein and mounted to allow relative movement of the handle link 60 therealong as the handle 16 is moved (i.e., the handle 16 and the handle link 60 are movable relative to the guide track member 76 and the guide track 78). In particular, the guide track link 76 can be tubular and can receive the handle link 60 therein in telescoping relation. The obstructing assembly 50 can comprise a pin 80 received in the guide track 78 and configured for non-relative longitudinal movement with the handle 16. More particularly, the pin 80 can be connected to the handle link 60, such as by receipt through the slots 58, and thereby to the handle 16 for longitudinal movement with the handle link 60 and the handle 16 such that the pin 80 moves longitudinally along the guide track 78 as the handle 16 is moved. In the illustrated embodiment, the guide track 78 is a pair of guide tracks defined along diametrically opposed portions of the guide link 76. Thus, the pin 80 is received in the guide tracks 78 and configured to move along the guide tracks 78 as the handle 16 is moved between the non-actuated position and the intermediate position, and between the intermediate position and the full actuated position.

In the illustrated embodiment, the guide track link 76 is fixedly mounted in the cockpit area 14 of the aircraft. For such mounting, the guide track link 76 can have a threaded region 82 disposed adjacent a first end 84 of the guide track link 76. The threaded region 82 can be received through an aperture 86 defined in a mounting bracket 88 which is fixedly secured to a static structure 90 provided in the cockpit area 14. For example, the bracket 88 can have a mounting portion 92 welded to the static structure 90, which can be a body portion of the aircraft. In particular, the aperture 86 can be defined in a flange portion 94 of the bracket 88. A pair of threaded members 96, 98 can be threadedly engaged with the guide track link 76 along the threaded region 82 for fixedly securing the guide track link 76 to the bracket 88, and in turn to the static structure 90 within the aircraft.

Spaced apart from the threaded region 82 on an opposite side of the guide track 78, the guide track link 76 can include a circumferential groove 100. The groove 100 can receive a lock ring 102 which seats against a bracket 104. The bracket 104 can include an aperture 106 through which the guide track link 76 is received, the aperture 106 being defined in a flange portion 108 of the bracket 104. A mounting portion 110 of the bracket 104 can be fixedly secured to the static structure 90 in the same manner as described in reference to the mounting portion 92 of the bracket 88 (e.g., welding). By this arrangement, the guide track link 76 is non-movably mounted to the static structure 90, whereas the handle link 60 and the handle 16 connected thereto for longitudinal movement therewith are movably mounted to the static structure 90 within the guide track link 76.

As best shown in FIG. 6, each guide track 78 of the illustrated guide track link 76 includes a first end 130 corresponding to the non-actuated position of the handle 16 and a second end 132 corresponding to the full actuated position of the handle 16. Each guide track 78 further includes a first longitudinal section 134 extending longitudinally from the first end 130 to an intermediate location 136 corresponding to the intermediate stop position, and a second longitudinal section 138 extending from the second end 132 to the intermediate location 136. As shown, the second longitudinal section 138 is offset laterally (about a circumference of the guide track link 76) relative or from the first longitudinal section 134.

The first longitudinal section 134 terminates at a shoulder 140 defined in the guide track 78 at the intermediate location 136. Accordingly, the first end of the first longitudinal section 134 is the first end 130 of the guide track 78 and the second end of the first longitudinal section 134 is the shoulder 140. The shoulder 140 obstructs longitudinal movement of the pin 80 along the first longitudinal section 134 beyond the intermediate location 136, and the pin 80 accordingly obstructs movement of the handle 16 beyond the intermediate stop position when the handle 16 is moved between the non-actuated position and the intermediate stop position. Accordingly, the obstructing assembly 50 can be considered as further including the guide tracks 78 and particularly the shoulders 140 thereof (i.e., the shoulders 140 prevent continuous longitudinal movement toward and past the intermediate stop position). In particular, cooperation between the pin 80 and the guide tracks 78 prevent continued longitudinal movement of the pin 80 to prevent corresponding movement of the handle from the intermediate stop position to the full actuated position.

Laterally or circumferentially adjacent the shoulder 140 at the intermediate stop position 136 is a tapered portion 142, which facilitates movement of the pin from the second longitudinal portion 138 back to the first longitudinal portion 134. Accordingly, the first end of the second longitudinal slot section 138 is the tapered portion 142 and the second end of the second longitudinal section is the second end 132 of the guide track 78. As will be described in more detail below, the pin 80 is movable laterally or rotatably from the first section 134 to the second section 138 at the intermediate stop position when the button actuator 18 is actuated. The pin 80 also moves laterally or rotatably in the slots 58 of the handle link 60. Thus, the button actuator 18 is configured to laterally or rotatably move the pin 80 in the guide tracks 78 and in the slots 58 when the handle 16 is at the intermediate stop position in the first longitudinal section 134 to allow further longitudinal movement of the pin 80 in the guide tracks 78 in the second longitudinal section 138 and corresponding movement of the handle 16 from the intermediate stop position to the full actuated position when the button actuator 18 is actuated.

Each guide track 78 further includes a locking recess section 144 at the second end 132 thereof that is laterally or circumferentially offset from the second longitudinal section 138. In particular, in the illustrated embodiment, the locking recess section 144 is laterally or circumferentially offset from the second longitudinal section 138 in the same direction as the first longitudinal section 134 is laterally or circumferentially offset from the second longitudinal section 138. As will be described in more detail below, the pin 80 can be moved laterally or rotatably from the second longitudinal section 138 to the locking recess section when at the second end 132 of the guide track 78 and the button actuator 18 is released. Cooperation between the pin 80 and the guide track 78 can then prevent longitudinal movement of the pin 80 to prevent corresponding movement of the handle 16 from the full actuated position to the intermediate stop position; however, actuation of the button actuator 18 to laterally or rotatably move the pin 80 in the guide track 78 (i.e., from the locking recess section 144 back to the second longitudinal section 138) allows longitudinal movement of the pin 80 and corresponding movement of the handle 16 from the full actuated position to the intermediate position.

The handle link 60 can further include at least one laterally extending slot 58 defined therein. In the illustrated embodiment, two diametrically opposed slots 58 are defined in the handle link 60 and each receives a respective end of the pin 80. The slots 58 guide lateral movement of the pin 80 (e.g., from the first longitudinal section 134 to the second longitudinal section 138). As shown in phantom in FIG. 5 5, a cover can be annular disposed around the handle assembly 12 and this cover can maintain the pin 80 within the assembly (i.e., prevents the pin from sliding along its axis).

The brake handle assembly 12 can further include a button link 150 (shown in isolation in FIG. 8) that is connected to the button actuator 18 for movement therewith. The button link 150 defines an angled slot 152 adjacent a first or inner end 154. As shown, the button link 150 of the illustrated embodiment has a generally flat, elongated configuration. The pin 80 is received through the angled slot 152. Depression of the button actuator 18 when the pin 80 is at the intermediate location 136 in the first longitudinal section 134 moves the pin 80 laterally or rotatably to the second intermediate section 138. The guide track 78 and the angled slot 152 are together configured to prevent lateral or rotatably movement of the pin 80 from the first longitudinal section 134 to the second longitudinal section 138 at the intermediate location 136 until the button actuator 18 is depressed. When the button actuator 18 is depressed, the button link 150 moves longitudinally and the angled slot 152 laterally or rotatably moves the pin 80 from the first longitudinal section 134 to the second longitudinal section (i.e., the pin 80 is moved so that the shoulder 140 is no longer an obstacle). Once in the second longitudinal section 138, the pin 80 is free to move longitudinally along the second longitudinal section and the handle link 60 and handle 16 are free to move from the intermediate stop position to the full actuated position.

As shown, the button link 150 can also include a second slot 156 that is longitudinally extending adjacent a first or outer end 158 of the button link 150. The pin 68 is received through the slot 156 for guiding longitudinal movement of the button link 150. A flange portion 160 can also be disposed adjacent the outer end 158 for connecting to a shaft portion 162 of the button actuator 18. A spring 164 can be annularly disposed about the outer end 158 of the button link 150. The spring 164 can have a first end 166 that acts against the flange portion 160 of the button link 150 and a second end 168 that acts against the end 56 of the handle link 60. By this arrangement, the spring 164 urges the button actuator 18 and thus the button link 158 connected thereto to a non-actuated position.

As best shown in FIG. 3, when the button actuator 18 is in the non-actuated or undepressed position, the angled slot 152 cooperates with the shoulder 140 to prevent lateral movement of the pin 80 and thereby limits movement of the button link 60 relative to the guide track link 76 beyond the intermediate stop position. Accordingly, movement of the handle 16 from the intermediate stop position to the full actuated position is obstructed. As will be described in more detail below, when the button actuator 18 is depressed, the button link 150 moves longitudinally and allows or forces movement of the pin laterally/rotatably from the first longitudinal section 134 to the section longitudinal section 138, which in turn allows movement of the pin 80 beyond the shoulder 140 from the intermediate location in the guide track 78 to the second end 132 of the guide track 78. This accordingly allows movement of the handle 16 from the intermediate stop position to the full actuated position.

At the second end 132 of the guide track 78, the pin 80 can move into the locking recess section 144 from the second section 138 when the pin 80 is at or adjacent the second end 132 of the second section 138 and the button actuator 18 is released and returned to its non-actuated position. In particular, when the button actuator 18 is released, the button link 150 returns to its nonactuated position as urged by the spring 164 and the angled slot 152 moves the pin 80 laterally into the locking recess section 144. When the button actuator 18 is in its non-actuated position, lateral movement of the pin 80 from the locking recess section 144 back to the second longitudinal section 138 is prevented by the configuration of the locking recess section 144, and particularly due to shoulder 170 defining the recess section 144. Accordingly, movement of the handle 16 from the full actuated position toward the non-actuated position, including toward the intermediate stop position, is obstructed unless the button actuator 18 is depressed.

Forward of the pin 80, another pin 180 can connect the handle link 60 and the guide track link 76. In particular, the pin 180 can be received through apertures 184 defined in the handle link 60 and through slots 180 defined in the guide track link 76. The slots 180 allow longitudinal movement of the handle link 60 relative to the guide track link 76, but prevent relative rotation.

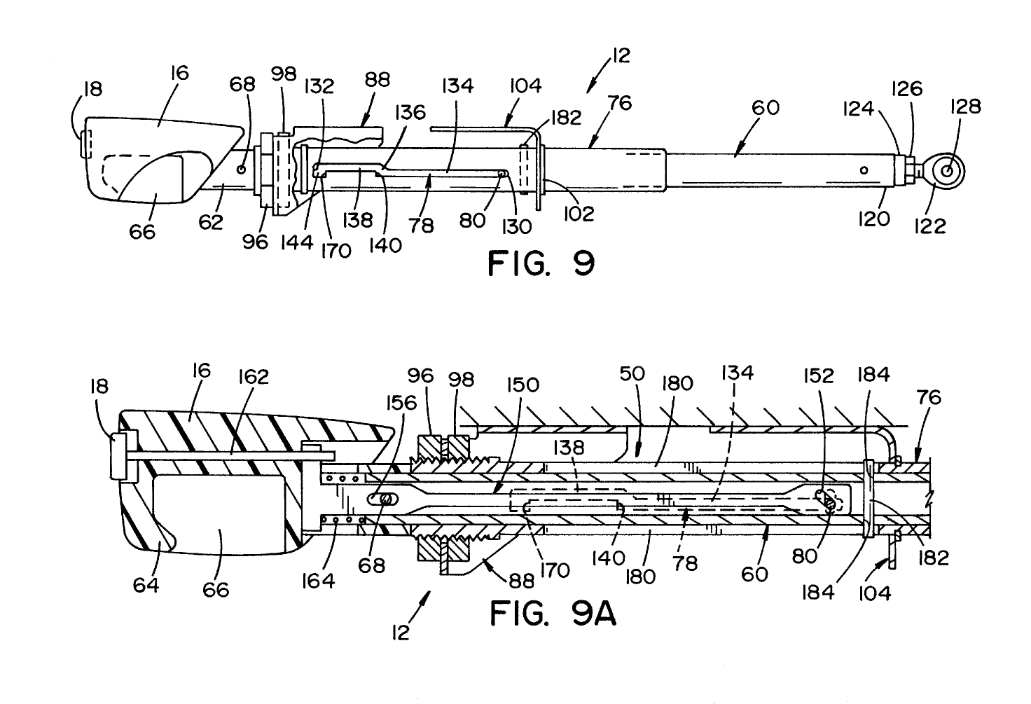

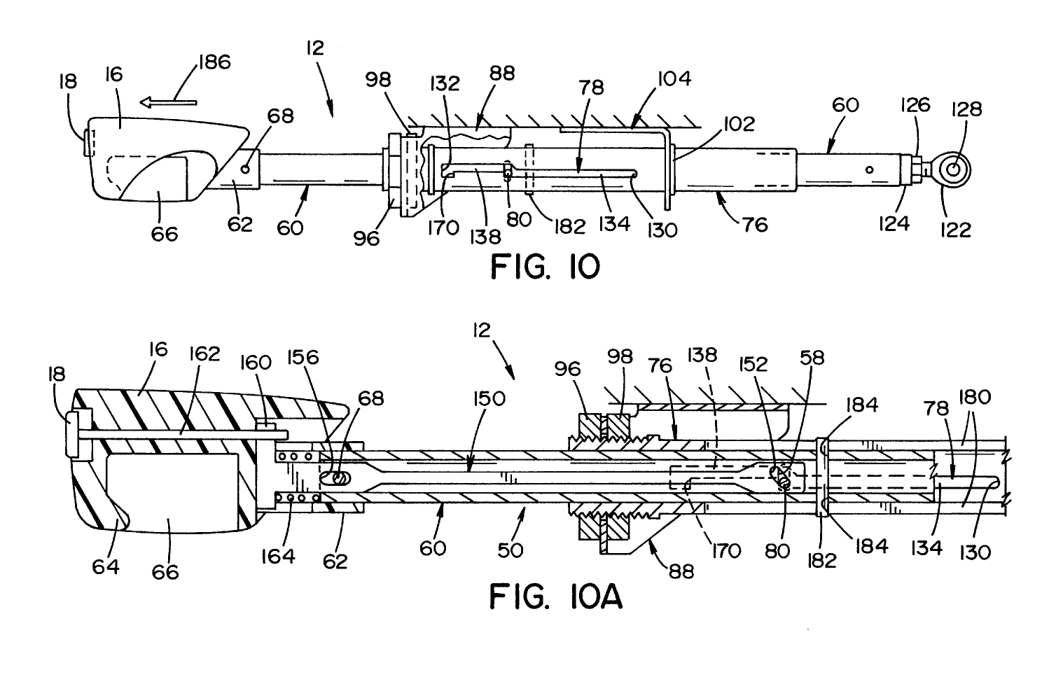

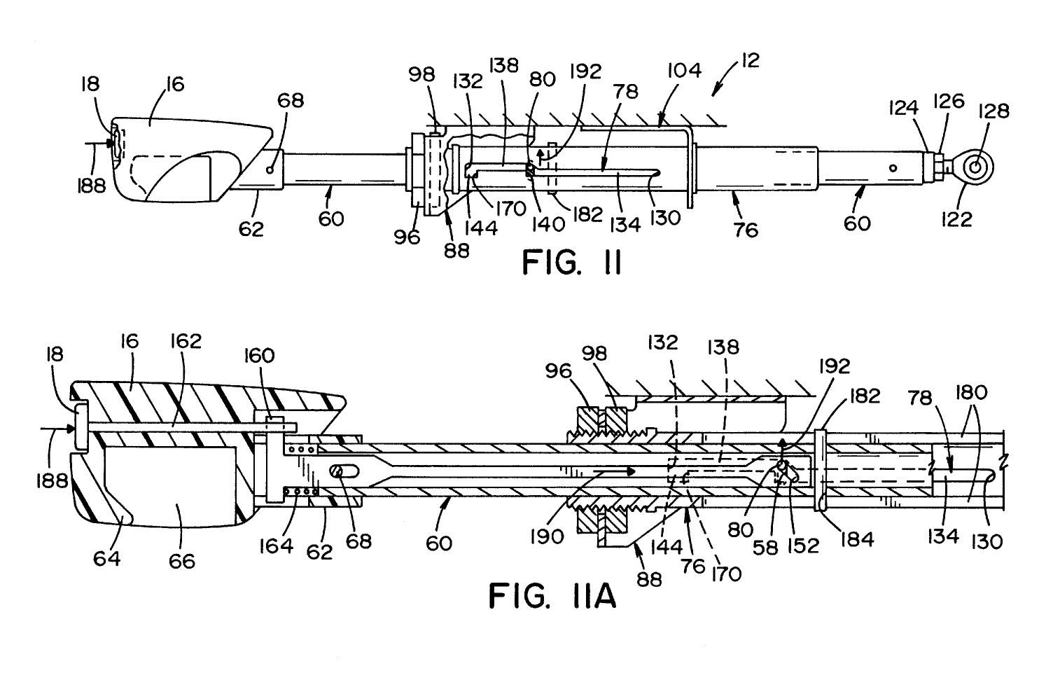

With reference now to FIGS. 9-13A, operation of the brake handle assembly 12 will now be described. As shown in FIGS. 9 and 9A, the handle 16 is in its non-actuated position wherein the brakes are disengaged. Also, the button actuator 18 is in its non-actuated position in FIGS. 9 and 9A. As already mentioned, the handle 16 is freely movable from the illustrated non-actuated position to the intermediate stop position shown in FIGS. 10 and 10A, wherein during movement between the non-actuated position of FIGS. 9 and 9A and the intermediate stop position of FIGS. 10 and 10A, the handle 16 operates the brake valve 20 to apply a modulated braking force in an emergency brake state. Movement of the handle 16 from the intermediate stop position of FIGS. 10 and 10A to the full actuated position shown in FIGS. 12 and 12A is obstructed to prevent operation of the brake in the parking brake state.

More particularly, the pin 80 is freely movable along the guide track 78, and particularly within the first longitudinal section 134 thereof, from the nonactuated position of FIGS. 9 and 9A to the intermediate stop position shown in FIGS. 10 and 10A. At the intermediate stop position, the shoulder 140 prevents further free movement of the pin 80 along the guide tracks 78 toward the full actuated position of FIGS. 12 and 12A. In particular, the obstructing assembly 50 comprising the pin 80, the guide track 78, the angled slot 152 and the lateral slots 58 obstructs movement of the pin 80 along the guide track 78 and into the second longitudinal section 138 to thereby prevent further longitudinal movement of the handle 16 (i.e. in the direction of arrow 186 of FIG. 10). In particular, the shoulder 140 prevents movement of the pin 80 in the direction of the arrow 186, whereas the angled slot 152 and the lateral slots 58 prevent lateral movement of the pin 80 from the first longitudinal section 134 to the second longitudinal section 138.

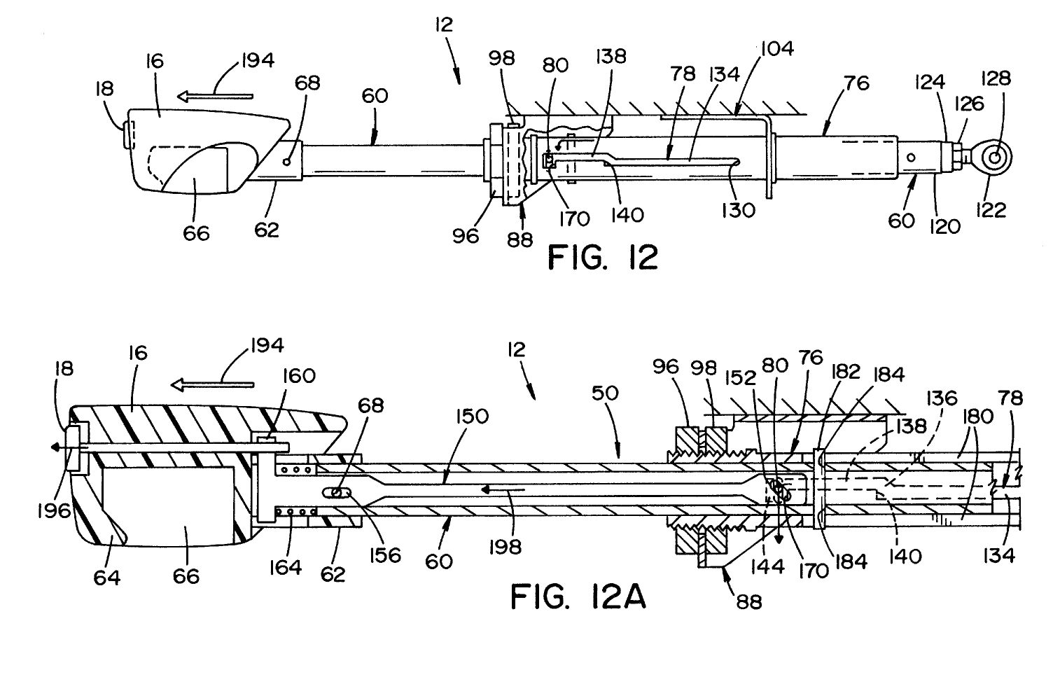

To disengage the obstructing assembly 50, the button actuator 18 is depressed as indicated by arrow 188 in FIGS. 11 and 11A. Movement of the button actuator is transferred to longitudinal movement of the button link 150 by the shaft 162 of the button actuator 18 and its connection to the button link 150. Movement of the button link 150 as indicated by arrow 190 causes the angled slot 152 to move in the same direction as the arrow 190, which in turn laterally moves the pin 80 along the lateral slot 58 as indicated by the arrow 192. This laterally shifts the pin 80 from the first longitudinal section 134 to the second longitudinal section 138. Once in the second longitudinal section, the handle 16 can again be pulled as indicated by the arrow 194 illustrated in FIGS. 12 and 12A such that the handle 16 can be moved from the intermediate stop position to the full actuated position. As shown, the pin 80 moves along the second longitudinal section 138 during such further movement of the handle.

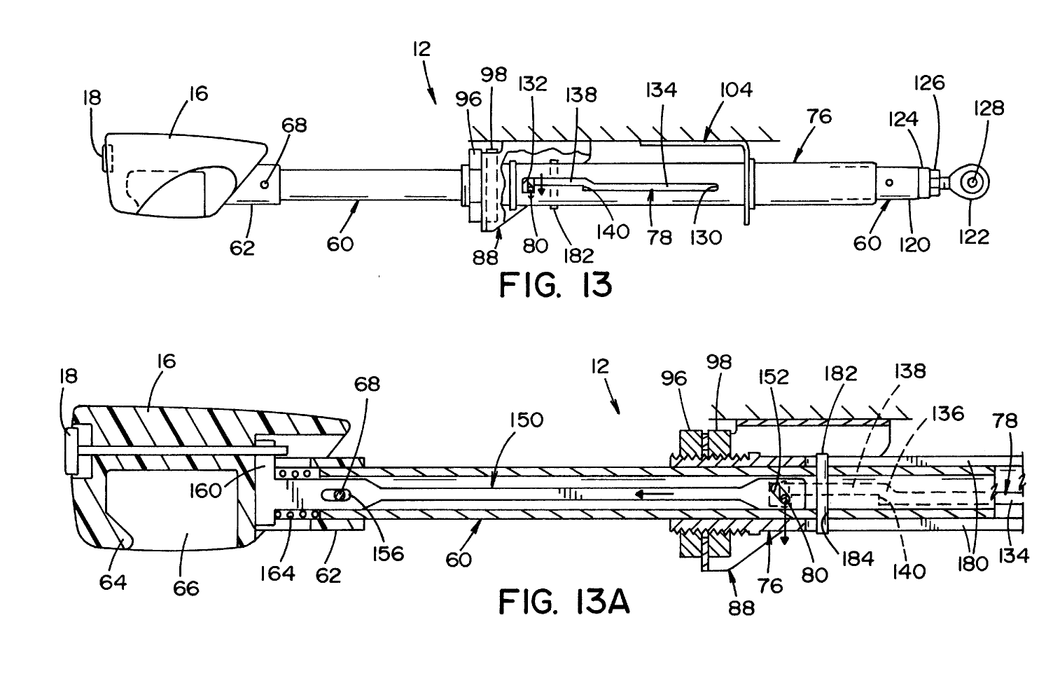

The button actuator 18 can be released as indicated by arrow 196, which via the spring 164 returns the button actuator 18 to its non-depressed or non-actuated position. This also moves the button link 150 as indicated by the arrow 198, which causes the pin 80 to again move laterally, this time into the locking recess section 144 of the guide track 78 whereby the handle 16 is locked in the full actuated position (i.e., parking brake mode). In particular, the angled slot 152 cooperates with the lateral slot 58 to laterally move the pin 80 from the second longitudinal section 138 into the locking recess section 144. This is best illustrated in FIGS. 13 and 13A.

To release the parking brake, with the pin 80 locked in the locking recess section 144, the button actuator 18 is depressed to move the button link 150 which, via the angled slot 152, laterally moves the pin 80 along the lateral slot 58 back into the second longitudinal section 138. From here, the pin 80 is freely movable along the guide tracks 78 to the intermediate stop position and back to the non-actuated position. The tapered portion 142 facilitates lateral transfer of the pin 80 from the second longitudinal section 138 back to the first longitudinal section 134 (i.e., the pin 80 is freely movable from the full actuated position in the second longitudinal section back into the first longitudinal section, past the intermediate stop position, all the way to the non-actuated position).

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A brake handle assembly for an aircraft emergency/parking brake, comprising:
a handle movable between a nonactuated position wherein the brake is disengaged and a full actuated position wherein the brake is fully engaged in a parking brake state, the handle freely movable from the nonactuated position to an intermediate stop position wherein during movement therebetween the brake applies a modulated braking force in an emergency brake state; and
a button actuator disposed on the handle, movement of the handle from the intermediate stop position to the full actuated position obstructed to prevent inadvertent operating of the brake in the parking brake state unless the button actuator is depressed.

2. The brake handle assembly of claim 1 wherein movement of the handle from the full actuated position toward the nonactuated position is obstructed unless the button actuator is depressed.

3. The brake handle assembly of claim 1 wherein the handle is mechanically connected to an emergency/parking brake valve so that the position of the handle is mechanically communicated to the valve.

4. The brake handle assembly of claim 3 wherein the handle is mechanically connected to the brake valve by a push/pull cable that transmits pushing and pulling action of the handle to the valve.

5. The brake handle assembly of claim 4 wherein the handle is further mechanically connected to the brake valve by a pivotal link, the pivotal link having one end connected to the handle for linear movement therewith and a second end connected to the push/pull cable for linear movement therewith, the pivotal link pivotally connected to a fixed mounting so that pulling movement of the handle is translated to pushing action of the push/pull cable and pushing action of the handle is translated to pulling action of the push/pull cable.

6. The brake handle assembly of claim 1 further including:
a handle link connected to the handle, the handle link longitudinally moving with the handle as the handle is moved between the nonactuated position and the fully engaged position and to any position between the nonactuated position and the fully engaged position, including the intermediate stop position.

7. The brake handle assembly of claim 6 further including:
a guide track link mounted to allow relative movement of the handle link therealong as the handle is moved, the guide track link having a guide track defined therein; and
a pin connected to the handle link for longitudinal movement with the handle link, the pin received in the guide track.

8. The brake handle assembly of claim 7 wherein the guide track includes a first end corresponding to the nonactuated position and a second end corresponding to the fully actuated position, the guide track further including a first longitudinal section extending longitudinally from the first end to an intermediate location corresponding to the intermediate stop position, and a second longitudinal section extending from the second end to the intermediate location, the second longitudinal section offset laterally from the first longitudinal section.

9. The brake handle assembly of claim 8 wherein the first longitudinal section terminates at a shoulder defined in the guide track link at the intermediate location, the shoulder obstructing longitudinal movement of the pin along the first longitudinal section beyond the intermediate location, and the pin accordingly obstructing movement of the handle beyond the intermediate stop position when the handle is moved between the nonactuated position and the intermediate stop position.

10. The brake handle assembly of claim 9 wherein movement of the pin laterally from the first longitudinal section to the second longitudinal section allows movement of the pin beyond the shoulder from the intermediate location to the second end of the guide track, and accordingly allows movement of the handle from the intermediate stop position to the full actuated position.

11. The brake handle assembly of claim 10 further including:
a button link connected to the button actuator for movement therewith, the button link defining an angled slot in which the pin is received, depression of the button actuator when the pin is at the intermediate location in the first longitudinal section moves the pin laterally to the second intermediate section.

12. The brake handle assembly of claim 11 wherein the guide track and the angled slot are configured to prevent lateral movement of the pin from the first longitudinal section to the second longitudinal section at the intermediate location until the button actuator is depressed.

13. The brake handle assembly of claim 8 wherein the guide track further includes a locking recess section at the second end thereof that is laterally offset from the second longitudinal section, the pin moving laterally from the second longitudinal section to the locking recess section when at the second end of the guiding track and the button actuator is released.

14. An aircraft brake handle assembly, comprising:
a handle longitudinally movable in a first direction from a nonactuated position to an intermediate stop position for applying a modulated emergency braking force, movement of the handle in the first direction beyond the intermediate stop position prevented by an obstructing assembly; and
a button actuator disposed on the handle and operatively connected to the obstructing assembly, actuation of the button actuator disengaging the obstructing assembly to allow movement of the handle in the first direction from the intermediate stop position to a full actuated position for applying a parking brake.

15. The aircraft brake handle assembly of claim 14 wherein the obstructing assembly comprises a pin configured for nonrelative longitudinal movement with the handle, the pin received in a guide track and configured to move along the guide track as the handle is moved between the nonactuated position and the intermediate position and between the intermediate position and the full actuated position.

16. The aircraft bake handle assembly of claim 15 wherein the guide track includes:
a first longitudinal slot section having a first end corresponding to the nonactuated position and a second end corresponding to the intermediate stop position, the second end formed as a shoulder preventing continuous longitudinal movement toward and past the intermediate stop position; and
a second longitudinal slot section having a first end corresponding to the intermediate stop position and a second end corresponding to the full actuated position, the second section laterally offset relative to the first section, and
wherein the pin is moveable laterally from the first section to the second section at the intermediate stop position when the button actuator is actuated.

17. The aircraft brake handle assembly of claim 16 wherein the guide track further includes:
a locking recess section disposed at the second end of the second section and laterally offset from the second section in the same direction as the first section is laterally offset from the second section, the pin moving into the locking recess section from the second section when the pin is at or adjacent the second end of the second section and the button actuator is released and returned to a nonactuated position.

18. The aircraft brake handle assembly of claim 14 further including a spring urging the button actuator toward a nonactuated position.

19. A handle assembly for an aircraft braking system, comprising:
a handle movable from a nonactuated position to an intermediate stop position for applying a modulated emergency braking force, the handle further movable from the intermediate stop position to a full actuated position for applying a parking brake;
a button actuator disposed on the handle;
a guide track member defining a guide track, the handle movable relative to the guide track member and the guide track; and
a pin received in the guide track, the pin connected to the handle for movement therewith such that the pin moves longitudinally along the guide track as the handle is moved, cooperation between the pin and the guide track preventing continued longitudinal movement of the pin to prevent corresponding movement of the handle from the intermediate stop position to the full actuated position, and wherein the button actuator is configured to laterally move the pin in the guide track when the handle is at the intermediate stop position to allow further longitudinal movement of the pin in the guide track and corresponding movement of the handle from the intermediate stop position to the full actuated position when the button actuator is actuated.

20. The handle assembly of claim 19 wherein cooperation between the pin and the guide track preventing longitudinal movement of the pin to prevent corresponding movement of the handle from the full actuated position to the intermediate stop position, actuation of the button actuator to laterally move the pin in the guide track allows longitudinal movement of the pin and corresponding movement of the handle from the full actuated position to the intermediate position.
